(19) United States
(12) Patent Application Publication
(10) Pub. No.: US 2004/0265565 A1
(43) Pub. Date: Dec. 30, 2004

(54) Microporous article containing flame retardant

(76) Inventors: Patrick J. Fischer, Saint Paul, MN (US); Robert M. Floyd, Maplewood, MN (US)

Correspondence Address: 3M INNOVATIVE PROPERTIES COMPANY, PO BOX 33427, ST. PAUL, MN, 55133-3427, US

(21) Appl. No.: 10/609,808

(22) Filed: Jun. 30, 2003

(51) Int. Cl. B32B 3/26

(52) U.S. Cl. 428/317.9; 428/316.6; 428/319.3

(57) ABSTRACT

Microporous articles are formed by solid-liquid phase separation from a diluent in combination with a thermoplastic polymer, flame retardant and a hindered amine synergist providing novel flame retardant articles. Such articles are useful in clothing, barriers, optical films in electronic devices (such as light reflective and dispersive films), printing substrates and electrical insulation.

### FIELD OF THE INVENTION

The present invention relates to flame retardant microporous articles (e.g., films, sheets or membranes) formed from a polymer and diluent composition in which the diluent is phase separated from a thermoplastic polymer to make the article.

### BACKGROUND OF THE INVENTION

Microporous films, sheets or membranes have a structure that enables fluids to flow through them. The effective pore size is at least several times the mean free path of the flowing molecules, namely, from several micrometers down to about 100 Angstroms. Such sheets are generally opaque, even when made from an originally transparent material, because the surfaces and internal structure scatter visible light.

Microporous membranes or films have been utilized in a wide variety of applications, such as the filtration of solids, the ultrafiltration of colloidal matter, diffusion barriers or separators in electrochemical cells, in the preparation of synthetic leather, and in the preparation of fabric laminates. The latter utilities require the membranes to be permeable to water vapor but not liquid water when preparing such articles as shoes, raincoats, outer wear, camping equipment such as tents, and the like. Moreover, microporous membranes or films are utilized for filtration of antibiotics, beer, oils, bacteriological broths, as well as for the analysis of air, microbiological samples, intravenous fluids, vaccines, and the like. Microporous membranes or films are also utilized in the preparation of surgical dressings, bandages, and in other fluid transmissive medical applications.

Microporous membranes or films may be laminated to other articles to make laminates having particular utility. Such laminates may include a microporous layer and an, outer shell layer to provide a particularly useful garment material. Further, the microporous films or membranes may be utilized as a tape backing to provide such products as vapor transmissive wound dressings or hair setting tapes.

The art is replete with various methods of producing microporous materials. One useful technology found is thermally induced phase separation (TIPS). The TIPS process is based on the use of a polymer that is soluble in a diluent at an elevated temperature and insoluble in the diluent at a relatively lower temperature. The “phase separation” can involve a solid-liquid phase separation, or a liquid-liquid phase separation. This technology has been employed in the preparation of microporous materials wherein thermoplastic polymer and a diluent are separated by a liquid-liquid phase separation as described in U.S. Pat. Nos. 4,247,498 and 4,867,881. A solid-liquid phase separation has been described in U.S. Pat. No. 4,539,256 wherein the thermoplastic polymer crystallizes out on cooling. The use of nucleating agents incorporated in the microporous material is also described as an improvement in the solid-liquid phase separation method, U.S. Pat. No. 4,726,989.

### SUMMARY OF THE INVENTION

The present invention provides new single and multilayer flame retardant microporous polymeric materials, prepared by a sold-liquid phase separation process, which contain an integral flame retardant and flame retardant synergist. The microporosity is achieved by preferably stretching the film, less preferably by diluent removal or by a combination of both techniques.

Accordingly, the present invention in its first aspect is a microporous material containing a crystallizable polymer component, a flame retardant additive and a flame-retardant synergist. More specifically, the present invention is a microporous material including:

(a) about 20 (preferably 30) to 90 parts by weight of a polymer component,

(b) about 0.1 to 70 (preferably greater than 10, most preferably 15 to 70) parts by weight of an diluent component, the diluent component being miscible with the polymer component at a temperature above the liquid-solid phase separation temperature, the diluent component able to phase separate from the polymer component through crystallization separation upon cooling below the liquid-solid phase separation temperature;

(c) about 1 to 10 parts by weight (preferably 2 to 5 parts by weight) of a flame retardant additive, and

(d) about 0.1 to 2 parts by weight (preferably 0.25 to 1 parts by weight) of a hindered amine flame retardant synergist.

A second aspect of the present invention is a method of making a microporous article including the steps of:

(a) melt-blending the above-described composition to form a solution;

(b) forming a shaped article of the melt-blended solution,

(c) cooling said shaped article to a temperature at which phase transition occurs between said diluent and said polymer component through crystallization precipitation of the polymer component to form a network of polymer domains, and

(d) creating porosity by stretching said article at least in one direction to separate adjacent crystallized polymer domains from one another, and/or by removing at least part of the diluent component, to provide a network of polymer spherulites connected by fibrils.

The microporous article may comprise a single microporous layer, or may comprise a multilayer article having at least one microporous layer as defined above. The multilayer article may include additional microporous layers, or additional nonporous layers, or one or more porous layers (such as a nonwoven layer) depending on the application and requirements. For example, the microporous article may comprise one or more flame retardant microporous layers laminated bonded or otherwise affixed to one or more non flame retardant microporous layers, one or more nonporous film layers or one or more nonwoven layers. The present invention also provides a multilayer film having a unified construction comprising at least 2, preferably 3, more preferably at least 5 substantially contiguous layers of organic polymeric material; the construction comprising layers comprising a flame retardant microporous film alternating with layers comprising a film that is not flame retardant.

The present invention also provides a process of preparing a flame-retardant multilayer film. The process includes melt processing organic polymeric material to form a unified construction of at least 2 substantially contiguous film layers of organic polymeric material, wherein at least one layer of the organic polymeric material comprises a microporous flame retardant film layer. Additional flame retardant layers can alternate with microporous non-flame retardant layers. Preferably, all the layers are simultaneously melt processed, and more preferably, all the layers are simultaneously coextruded.

A further aspect of the present invention provides a process of preparing a multilayer film, the process comprising melt processing organic polymeric material to form a unified construction of at least 2 substantially contiguous layers of organic polymeric material, the construction comprises film layers comprising at least one microporous flame retardant film layer, and microporous non-flame retardant film layers.

The microporous articles of the invention may be used in many applications where non-flammability is desired. Heretofore, rendering microporous films flame-retardant has been difficult. Porous articles are generally more flammable than nonporous articles due to the relative large surface area exposed to air. Additionally “oil-in” microporous films, in which diluent is retained in the porous structure, generally enhance the flammability of the article by providing a relatively volatile fuel source. Unexpectedly, despite the large surface area of the microporous article and the presence of a flammable diluent component, porous articles of the present invention may be made which are difficult to ignite, propagate flame slowly, and which may be self-extinguishing. The multilayer microporous films have improved flame resistance over single-layer blending and may have a particle free surface that can eliminate the fouling of substrates and delamination of flame retardant particles from the microporous film surface.

Further, it has been found that the addition of a hindered amine flame retardant synergist allows the use of much less flame retardant additive to achieve a given level of flame retardancy. For example, a given level of flame retardancy may be achieved using as little as 1 wt. % of flame retardant additive. Heretofore, microporous films have required at least 10 wt. % of a flame retardant to render the film non-flammable. However these higher amounts of flame retardant additive may interfere with the liquid-solid phase separation resulting in a non-uniform microporous article, or one having poor mechanical properties. Additionally, large amounts of flame retardant, such as halogenated flame-retardants may raise environmental or health-related concerns.

### DETAILED DESCRIPTION

The microporous material of the present invention includes a crystallizable polymer component, and diluent component, and 1 to 10 (preferably 2 to 5) parts by weight of a flame retardant additive, and 0.1 to 2 (preferably 0.25 to 1) parts by weight of a flame retardant synergist.

As used herein, the term “polymer component” refers only to conventional polymers that are melt-processible under ordinary melt-processing.

As used herein, the term “crystalline” with regard to polymer components includes polymers which are at least partially crystalline, preferably having a crystallinity of greater than 20 weight % as measured by Differential Scanning Calorimetry (DSC). Crystalline polymer structures in melt-processed polymers are known to those skilled in the art.

As used herein, the term “melting temperature” refers to the temperature at or above which a polymer component alone or in a blend with a diluent component will melt.

As used herein, the term “crystallization temperature” refers to the temperature at or below which a polymer component alone or in a blend with a diluent, will crystallize.

As used herein, the term “liquid-solid phase separation temperature” refers to the temperature at or below which a solution of a compatible polymer and diluent mixture, i.e., a homogeneous polymer diluent solution, phase separates by crystallization of the polymer component.

As used herein, the term “diluent component” refers to the diluent component in solid-liquid phase separation.

As used herein, the term “compatible mixture” refers to a fine dispersion of one polymer component (less than 1 micrometer particle size) in a continuous matrix of a second polymer component or a fine inter-penetrating network of both polymer components, and “compatible” refers to two or more polymers capable of forming such dispersions or interpenetrating networks with each other. Compatibility requires that at least one polymer component of a compatible mixture be at least partially miscible with the other polymer components.

As used herein, the term “oil-in” refers to a microporous film made by solid-liquid phase separation in which the diluent component is not removed.

As used herein, the term “oil-out” refers to a microporous film made by solid-liquid phase separation in which the oil component is essentially removed.

As used herein “flame retardant” means polymers in which basic flammability has been reduced by some modification as measured by one of the accepted test methods such as the UL 94 Horizontal Burn test, the DIN 4102 Vertical Burn test or the Federal Motor Vehicle Safety Standard 302.

“Flame retardant additive” means a compound or mixture of compounds that when incorporated (either mechanically or chemically) into a polymer serves to slow or hinder the ignition or growth of the fire.

“Flame retardant microporous articles” means microporous polymeric films, membranes, sheets, or other profiles which have been rendered flame retardant by means of a flame retardant-additive and flame retardant synergist.

“Hindered amine” refers to secondary or tertiary amines having at least one, preferably 2, secondary or tertiary carbon atoms alpha to the nitrogen atom.

“(Cyclo)alkoxyamine” refers to alkoxy- or cycloalkoxy- substituted amines, including combinations thereof.

In general, flame retardant additives preferably form a homogeneous mixture (dispersion or solution) with the polymer and diluent components at the processing temperatures used, and may melt above or below the processing temperature. In order that the flame retardant additive not weaken the structure of the ultimate article (such as a film or sheet), the additive should not inhibit the crystal nucleation of the polymer component during phase separation such that the microstructure grows so large as to adversely weaken the film.

Useful flame retardant additives include halogenated organic compounds, organic phosphorus-containing compounds (such as organic phosphates), and inorganic compounds. These additives and synergists are added to or incorporated into the polymeric matrix of the microporous article in sufficient amounts to render an otherwise flammable polymer flame retardant as measured by the Underwriters Laboratory Horizontal Burn test (UL 94 HB), the Deutsches Institut für Normung Vertical Burn test (DIN 4102 B2) and/or the Federal Motor Vehicle Safety Standard 302.

Preferred flame retardants are those that react with the polymer in the condensed phase and remove hydrogen and hydroxy radicals in the vapor phase, such as halogenated and organophosphorus flame retardants. A mixture of two or more individual flame retardant additives and two or more flame retardant synergists may be used. For example, halogenated flame retardants are often used in combination with antimony trioxide.

Halogenated organic flame retardant additives are thought to function by chemical interaction with the flame: the additive dissociates into radical species that compete with chain propagating and branching steps in the combustion process. An additional method occurs in polymers with tertiary carbon; alphatic bromine can cause chain scission. This leads to fast dripping and allows the material to melt away from the flame. Useful halogenated additives are described, for example, in the Kirk-Othmer Encyclopedia of Technology, 4^{th} Ed., vol. 10, pp 954-76, John Wiley & Sons, N.Y., N.Y., 1993.

Included within the scope of halogenated organic flame retardant additives are substituted benzenes exemplified by tetrabromobenzene, hexachlorobenzene, hexabromobenzene, and biphenyls such as 2,2′-dichlorobiphenyl, 2,4′-dibromobiphenyl, 2,4′-dichlorobiphenyl, hexabromobiphenyl, octabromobiphenyl, decabromobiphenyl, decabromodiphenyl ethane and halogenated diphenyl ethers, containing 2 to 10 halogen atoms.

The preferred halogenated organic flame retardant additives for this invention are aromatic halogen compounds such as brominated benzene, chlorinated biphenyl, or a compound comprising two phenyl radicals separated by a divalent linking group (such as a covalent bond or alkylene group) and having at least two chlorine or bromine atoms per phenyl nucleus, chlorine containing aromatic polycarbonates, and mixtures of at least two of the foregoing. Especially preferred are decabromodiphenyl oxide, pentabromodiphenyl oxide, decabromodiphenyl ethane and octabromodiphenyl oxide.

Among the useful organic phosphorus additives are organic phosphorus compounds, phosphorus-nitrogen compounds and halogenated organic phosphorus compounds. Often organic phosphorus compounds function as flame retardants by forming protective liquid or char barriers, which minimize transpiration of polymer degradation products to the flame and/or act as an insulating barrier to minimize heat transfer.

In general, the preferred phosphate compounds are selected from organic phosphonic acids, phosphonates, phosphinates, phosphonites, phosphinites, phosphine oxides, phosphines, phosphites or phosphates. Illustrative is triphenyl phosphine oxide. These can be used alone or mixed with hexabromobenzene or a chlorinated biphenyl and, optionally, antimony oxide. Phosphorus-containing flame retardant additives are described, for example, in Kirk-Othmer (supra) pp. 976-98.

Typical of the preferred phosphorus compounds to be employed in this invention would be those having the general formula O═P(OQ)₃, and nitrogen analogs thereof where each Q represents the same or different radicals including hydrocarbon radicals such as alkyl, cycloalkyl, aryl, alkyl substituted aryl and aryl substituted alkyl; halogen, hydrogen and combinations thereof provided that at least one of said Q's is aryl. Typical examples of suitable phosphates include, phenylbisdodecyl phosphate, phenylbisneopentyl phosphate, phenylethylene hydrogen phosphate, phenyl-bis-3,5,5′-trimethylhexyl phosphate), ethyldiphenyl phosphate, 2-ethylhexyl di(p-tolyl) phosphate, diphenyl hydrogen phosphate, bis(2-ethyl-hexyl) p-tolylphosphate, tritolyl phosphate, bis(2-ethylhexyl)-phenyl phosphate, tri(nonylphenyl) phosphate, phenylmethyl hydrogen phosphate, di(dodecyl) p-tolyl phosphate, tricresyl phosphate, triphenyl phosphate, halogenated triphenyl phosphate, dibutylphenyl phosphate, 2-chloroethyldiphenyl phsophate, p-tolyl bis(2,5,5′-trimethylhexyl) phosphate, 2-ethylhexyldiphenyl phosphate, diphenyl hydrogen phosphate, and the like. The preferred phosphates are those where each Q is aryl. The most preferred phosphate is triphenyl phosphate. It is also preferred to use triphenyl phosphate in combination with hexabromobenzene and, optionally, antimony oxide.

Also suitable as flame-retardant additives for this invention are compounds containing phosphorus-nitrogen bonds, such as phosphonitrilic chloride, phosphorus ester amides, phosphoric acid amides, phosphonic acid amides or phosphinic acid amides.

Among the useful inorganic flame retardant additives include compounds of antimony, such as include antimony trioxide, antimony pentoxide, and sodium antimonate; boron, such as barium metaborate, boric acid, sodium borate and zinc borate; aluminum, such as aluminum trihydrate, magnesium, such as magnesium hydroxide; molybdenum such as molybdic oxide, ammonium molybdate and zinc molybdate, phosphorus, such as phosphoric acid; and tin, such as zinc stannate. The mode of action is often varied and may include inert gas dilution, (by liberating water for example), and thermal quenching (by endothermic degradation of the additive). Useful inorganic additives are described for example in Kirk-Othmer (supra), pp 936-54.

The particle size of the inorganic additive (or organic additives, which do not melt) should be less than the thickness of the flame retardant film layer(s) into which it is incorporated to ensure uniform thickness of the article. Preferably the particle size is less than one-half, more preferably less than one-third the thickness of the flame retardant film layer(s). In general, the smaller the particle, or the more surface area the particle presents, the more effective the flame retardant properties.

Especially useful are mixed additives of an antimony additive and a halogenated organic additive, describes as “antimony-halogen” additives which produces an especially effective flame retardant. The two additives react synergistically at flame temperatures to produce an antimony halide or oxyhalide which produce radical species (which compete with chain propagating and branching steps in the combustion process) as well as promoting char formation.

The flame retardant additives are generally incorporated into the flame retardant film layers by addition of the additive(s) to the melt prior to film formation. The materials may be added neat, or incorporated into the diluent or polymer. Care should be exercised to choose an additive that is stable at the melt temperature of the polymer.

Flame retardant additives are added in sufficient amounts to render the microporous article flame retardant. Typically the flame retardant additives are added in amounts of 1 to 10 parts by weight and the flame retardant synergist is added in amounts of 0.1 to 2.0 parts by weight.

Useful hindered amines include secondary or tertiary amines having at least one, preferably 2, secondary or tertiary carbon atoms alpha to the nitrogen atom, and an organooxy group attached to the nitrogen atom. The hindered amine may be aliphatic or aromatic, polymeric or non-polymeric and cyclic or non-cyclic. Useful hindered amines are those alkoxy-, cycloalkoxy- and aryloxy-amines comprising a moiety of the formula:

R¹O—NR²R³, wherein

R¹ is an alkyl group, a cycloalkyl group, an aryl group or combinations thereof. Alkyl groups may contain 1-18 carbon atoms and may be linear or branched, and may be substituted by one or more, preferably one, hydroxy group. Cycloalkyl groups may have one or two rings, 5 to 8 carbon atoms in each ring and may be substituted by one or more, preferably one, hydroxy group(s). Aryl groups may have one or two rings and may be substituted by one or more hydroxy groups. Combinations of alkyl, cycloalkyl and aryl groups are also contemplated such as alkyl-substituted cycloalkyl groups, alkyl-substituted aryl group, aralkylene groups or cycloalkyl alkylene groups.

R² and R³ are independently an alkyl group, a cycloalkyl group, an aryl group and may be substituted by one or more, preferably one, hydroxy group. R² and R³ may be taken together to form a heterocyclic aliphatic or aromatic ring. At least one of R² and R³, preferably both R² and R³ have a secondary or tertiary carbon atom alpha to the nitrogen atom. Alkyl groups may contain 1-18 carbon atoms and may be may be substituted by one or more, preferably one, hydroxy group. Cycloalkyl groups may have one or two rings, 5 to 8 ring carbon atoms and may be substituted by one or more, preferably one, hydroxy group(s). Combinations of alkyl, aryl and cycloalkyl groups are also contemplated.

The above formula may represent a compound per se, or a moiety pendant from an oligomeric or polymeric chain. Thus one of R² or R³ may be connected by a covalent bond or an organic linking group to a polymeric chain.

While not wishing to be bound by theory, it is believed that the hindered amine synergist fragments to form a free radical (R¹O• and •NR²R³ or R¹• and •ONR²R³) which reacts with the crystallizable polymer leading to chain scission. The cleaved polymer chains tend to drip more readily, thereby removing heat and reducing flame propagation.

Many hindered amines useful as flame retardant synergists are known in the art. Generally, the most useful hindered amines are those derived from a tetramethyl piperidine, and may be polymeric or non-polymeric. Polymeric piperidinyl compounds include high molecular weight (i.e., above about 500), oligomeric, and polymeric compounds that contain a polyalkylpiperidine pendant group, where the polymeric chain may be polyesters, polyethers, polyamides, polyamines, polyurethanes, polyureas, polyaminotriazines and copolymers thereof. Preferred hindered amines are those containing polymeric compounds having substituted hydroxypiperidines moieties, (e.g. alkoxypiperidines, aryloxypiperidines and cycloalkoxypiperidines) including the polycondensation product of a hydroxypiperidines with a suitable acid or with a triazine.

Preferred hindered amines include substituted N-hydroxy-2,2,6,6-tetraalkyl piperidine compounds, due to the ready availability of the compounds. Preferred hindered amines include: 1) 1,3-propanediamine, N,N″-1,2ethanediylbis- reaction product with cyclohexane and peroxidized N-butyl-2,2,6,6-tetramethyl-4-piperidinamine-2,4,6-trichloro-1,3,5-triazine reaction products (Flamestab NOR 116 FF from Ciba-Geigy Corp.); and

2) bis(2,2,6,6-tetramethyl-1-octyloxy-4-piperidinyl sebacate) (Tinuvin™ 123 from Ciba-Geigy Corp.).

Crystallizable polymers suitable for use in the preparation of microporous materials of the invention are well known and readily commercially available. The useful polymers are melt processable under conventional processing conditions. That is, on heating they will easily soften and/or melt to permit processing in conventional equipment such as an extruder to form a sheet. Crystallizable polymers, upon cooling their melt under controlled conditions, spontaneously form geometrically regular and ordered chemical structures. Preferred crystallizable polymers for use in the present invention have a high degree of crystallinity and also possess a tensile strength of at least about 70 kg/cm²(1000 psi).

Examples of suitable crystallizable polymers include addition polymers such as polyolefins and condensation polymers such as polyesters and polyamides. Useful polyolefins preferably include the polymers of ethylene and propylene but also may include methylpentene, butene, 1-octene, styrene, and the like, and copolymers of two or more such olefins that may be polymerized to contain crystalline and amorphous segments and mixtures of stereo-specific modification of such polymers e.g., mixtures of isotactic polypropylene and atactic polypropylene, isotactic polystyrene and atactic polypropylene. Useful polyesters include polyethyleneterephthalate, polybutylene-terephthalate, polyhexamethyleneadipate, polyhexamethylenesuccinate, and polyester copolymers. Useful polyamides include polyhexamethyleneadipamide, polyhexamethylenesebacamide and polycaprolactam. These are described, for example, in U.S. Pat. Nos. 4,247,498, 4,539,256, 4,726,989, 4,867,881, and 4,849,311, which are incorporated herein by reference.

If desired, a nucleating agent, such as β-phase nucleating agent, may be used. The nucleating agent employed in the present invention may serve the important functions of inducing crystallization of the polymer from the liquid state and enhancing the initiation of polymer crystallization sites so as to hasten the crystallization of the polymer. Because the nucleating agent serves to increase the rate of crystallization of the polymer, the size of the resultant polymer particles or spherulites is reduced. The use of nucleating agents in the preparation of microporous materials has been described in U.S. Pat. No. 4,726,989 (Mrozinski), the disclosure of which is incorporated herein by reference. β-phase nucleating agents are known and are described, for example, in Jones, et al., Makromol. Chem., vol. 75, 134-158 (1964) and J. Karger-Kocsis, Polypropylene: Structure, Blends and Composites, vol. 1, 130-131(1994).

Some examples of nucleating agents which have been found useful for purposes of the present invention include aryl alkanoic acid compounds, benzoic acid compounds, and certain dicarboxylic acid compounds. In particular, the following specific nucleating agents have been found useful: dibenzylidine sorbitol, titanium dioxide (TiO₂), talc, adipic acid, benzoic acid, and fine metal particles. It will be understood that the foregoing nucleating agents are given by way of example only, and that the foregoing list is not intended to be comprehensive. Other nucleating agents, such as beta- nucleating agents, which may be used in connection with thermoplastic polymers are well known, and may also be used to prepare microporous materials in accordance with the present invention. One such beta nucleating agent is N′,N′,-dicyclohexyl-2,6-napthalene dicarboxamide, available as NJ-Star NU-100™ from New Japan Chemical Co. Chuo-ku, Osaka. Japan.

Compounds suitable as the diluent component for blending with the crystallizable polymer to make the microporous materials of the invention are liquids or solids at room temperature and in which the crystallizable polymer will dissolve to form a solution at the melting temperature of the crystallizable polymer but will phase separate on cooling, at or below the crystallization temperature of the crystallizable polymer. Preferably, these compounds have a boiling point at atmospheric pressure at least as high as the melting temperature of the crystallizable polymer. Compounds having lower boiling points may be used in those instances where superatmospheric pressure may be employed to elevate the boiling point of the compound to a temperature at least as high as the melting temperature of the crystallizable polymer. Generally, suitable diluent compounds have a solubility parameter and a hydrogen bonding parameter within a few units of the values of these parameters for the crystallizable polymer.

The useful diluents are those that form solutions with the polymer component at elevated temperatures and phase separate upon cooling and include various types of organic compounds including paraffinic (alkane) and aromatic acids, alkanes, aromatic and cyclic alcohols, aldehydes, primary and secondary amines, aromatic and ethoxylated amines, diamines, amides, esters and diesters, ethers, ketones and various hydrocarbons and heterocylics. Particularly useful diluents are, for example, phthalates, such as dioctyl-, diethyl- and dibutyl-; mineral oil; mineral spirits; triethyleneglycol; methylnonylketone; decanoic and oleic acids, and decyl alcohol.

Some examples of blends of crystallizable polymers and blending compounds which are useful in preparing microporous materials according to the present invention include: polypropylene with mineral oil, dioctyl phthalate or mineral spirits; polypropylene-polyethylene copolymer with mineral oil; polyethylene with mineral oil or mineral spirits; polyethylene terephthalate or polybutylene terephthalate with diethylphthalate; polyester elastomer with dioctylphthalate, and nylon 6 (polycaprolactamn) with triethylene glycol.

A particular combination of polymer and, blending compound may include more than one polymer, i.e., a mixture of two or more polymers, and/or more than one blending compound. Mineral oil and mineral spirits are examples of mixtures of blending compounds since they are typically blends of hydrocarbon liquids. Blends of liquids and solids may also serve as the blending compound. It should be understood that the polymer may include blended therein certain conventional additive materials in limited quantity so as not to interfere with the formation of the microporous material of the invention and so as not to result in unwanted exuding of the additive.

Particularly useful are polypropylene and high density polyethylene. Mixtures of polymers may also be used as long as they are miscible with the diluent upon heating and form compatible mixtures upon cooling. While high density polyethylene films have lower use temperatures, they may be preferred over polypropylene films since they yield better hand softness, and tear resistant characteristics, especially with “oil-out” films.

Miscibility and compatibility of polymers are determined by both thermodynamic and kinetic considerations. Common miscibility predictors for non-polar polymers are differences in solubility parameters or Flory-Huggins interaction parameters. Unlike miscibility, compatibility is difficult to define in terms of exact thermodynamic parameters, since kinetic factors, such as melt processing conditions, degree of mixing, and diffusion rates can also determine the degree of compatibility.

Some examples of compatible polyolefin blends are: low density polyethylene and ethylene propylene diene terpolymer; low density polyethylene and ethylene vinyl acetate copolymer; polypropylene and ethylene propylene rubber; polypropylene and ethylene alpha-olefin copolymers; polypropylene and polybutylene.

Compatibility affects the range of useful polymer concentrations. If the polymers are incompatible, that range of compositions can be quite narrow, restricted to very low polymer concentrations, and of minimal practical usefulness in making the articles of this invention. However, if polymers are compatible, a common solvent can promote their miscibility into the composition regions of much higher polymer concentrations, thus allowing the use of common processing techniques such as extrusion to make articles of this invention. Under these conditions, all components in the melt are miscible and phase-separate by crystallization precipitation upon cooling below the phase separation temperature. The rate of cooling is quite rapid (preferably sufficient so that the melt-blended solution cools below the phase boundary in 30 seconds or less) and controlled by the process conditions that minimize the size of phase-separated microdomains and provides uniformity on a microscopic level.

Compatibility also affects the film uniformity. Cast films that are made from compatible blends of polymer are transparent which confirms the uniformity on, a microscopic level. This uniformity is of great importance for successful post-processing: films with a lesser degree of uniformity made from incompatible polymers break easily during stretching when stretching is used to create porosity. Film uniformity is also important in some applications, such as thermal shutdown battery separators, for which reliable shutdown performance on a microscopic level is desirable to prevent local overheating when a short circuit develops across the separator.

The microporous article or at least one microporous layer in a multilayer article may be prepared by melt-blending a polymer component, i.e. polymer or polymer mixture above described, to form a solution by heating the mixture with a diluent component at a temperature above the melting temperature of the polymer.

The microporous article may also contain other additive materials in limited quantity so as also not to interfere with the formation of the microporous article of the present invention, and so as not to result in unwanted exuding of the additive. Such additives may include anti-static materials, plasticizers, fluorochemicals, UV absorbers, nucleating agents, hygroscopic metal salts alkoxides and the like. The amount of total additive content is typically less than 10% of the weight of the polymeric mixture, preferably, less than 6% by weight, and more preferably less than 2% by weight.

It has been found that certain heat stabilizers reduce the effectiveness of the flame retardant additive/synergist combination—and thereby increase the flammability of the microporous article. It is believed that these heat stabilizers scavenge the radicals produced by the synergist. Heat stabilizers are preferably in amounts less than 0.5 wt. %, or additional additive/synergist may be warranted.

The melt solution is prepared by mixing the polymer component, the diluent component, and the flame retardant additive under agitation such as that provided by an extruder and heating until the temperature of the mixture is above the liquid-solid phase separation temperature. At this point the mixture becomes a melt solution or single phase. Once the melt solution is prepared, a shaped article is then formed by known methods, for example, employing an extruder.

The preferred article according to the present invention is in the form of a sheet or film, although other article shapes are contemplated. For example, the article may be in the form of a tube or filament. Other shapes that can be made according to the disclosed process are intended to be within the disclosed invention.

Cooling of the shaped article occurs either in the extruder, at or near the die at the extruder discharge, or preferably by casting the Shaped material onto a casting wheel. The microporous films of the present invention are typically cooled by casting on a patterned drum. Protrusions in the pattern result in less contact between the metal cooling drum and the hot solution (or melt); thus slowing the cooling when compared to that observed with a smooth (non-patterned) drum. Cooling causes the phase transition to occur between the diluent and the polymer components. This occurs by crystallization precipitation of the polymer component to form a network of polymer domains.

The shaped material (e.g. the oil-in cast film) is nonporous at this stage and is rendered microporous by orientation (stretching), diluent removal or a combination thereof. The stretching is at least in one direction to separate adjacent crystallized polymer domains from one another to provide a network of interconnected micropores. Stretching may be achieved by pulling the films with either a length orienter and/or tenter (i.e. orienting down-web, cross-web or both). When the film is pulled in more than one direction, the degree of stretch may be the same or different in each direction.

The article formed from liquid-solid phase separation, before orientation, is solid and generally transparent comprising an aggregate of a first phase of spherulites of crystallized thermoplastic polymer and a second phase of the diluent component. Independently, the flame retardant additive and flame retardant synergist may be dissolved in the polymer component and/or the diluent component or may form a third phase(s) of flame retardant additive and/or flame retardant synergist dispersed in the matrix as a solid or liquid. The polymer domains may be described as spherulites and aggregates of spherulites of the polymer. Adjacent domains of polymer are distinct but they have a plurality of zones of continuity. That is, the polymer domains are generally surrounded or coated by the diluent component, but not completely. There are areas of contact between adjacent polymer domains where phase separation has not occurred and there is a continuum of polymer from one domain to the next adjacent domain in such zones of continuity.

On orienting or stretching, the polymer domains are pulled apart, permanently attenuating the poly er in the zones of continuity thereby forming fibrils that interconnect the polymer spherulites, and forming minute voids between coated particles, creating a network of interconnected micropores, thereby rendering the article permanently translucent. On orienting or stretching, the diluent component remains coated on or surrounds, at least partially, the surfaces of the resultant thermoplastic polymer domains. The degree of coating depends upon the affinity of the diluent for the surface of the polymer domain, whether the diluent is a liquid or solid, whether orientation dislodges or disrupts the coating and on other factors which may be relevant. The domains are usually at least partially coated after orientation. Substantially all of the domains appear to be connected by fibrils. The size of the micropores is controlled by varying the degree of stretching, percent of diluent, flame retardant additive and synergist components, melt-quench conditions, diluent removal and heat-stabilization procedures. The fibrils for the most part do not appear to be broken by stretching but they are permanently stretched beyond their elastic limit so that they do not elastically recover to their original position when the stretching force is released. As used herein, “orienting” means such stretching beyond the elastic limit so as to introduce permanent set or elongation of the article. Stretching below the elastic limit is also effective if the article is annealed or heat-set while under tension.

An extruder with either a blown film die or a cast film die and a casting wheel can be used to initiate the thermal phase separation process as described above. These resulting films can be washed and/or stretch oriented in either a uniaxial or biaxial manner to yield a microporous film. Further, the oriented films may be annealed or heat-set to retain the orientation imparted. These microporous films are both porous and breathable as demonstrated by air-flow/Gurley values in the range of 25 to 1000 sec/50 cc and moisture vapor transmission rates (MVTR's) in the range of 5,000 to 6,000 g/m²/day. The films are thus suitable for many breathable garment and barrier film applications.

The process may further comprise a diluent removal step. This can be done using stretched or unstretched film to achieve the desired degree of porosity. The removal of diluent may be carried out by extraction, displacement or other known methods. The diluent component may be removed by any suitable solvent or displacement agent that is additionally a non-solvent for the polymer component, the flame retardant additive and flame retardant synergist. The miscibility or solubility of the diluent in the chosen solvent will determine the effectiveness of the chosen solvent and the times required to fully or partially remove the diluent component. If a displacement, agent is used, it is preferably chosen from liquid flame retardant additives that can displace the diluent component and enhance the flame retardant properties of the article.

Preferably the diluent is retained in the microporous article due to cost considerations and flexibility in choosing the flame retardant additive and synergist. If not removed, the “oil-in” microporous article preferably contains greater than 10 parts by weight diluent (most preferably 15 to 70 parts by weight) diluent. Oil-out microporous articles typically contain less that ten parts by weight of diluent after oil removal. If an “oil-out” microporous article is desired, the flame retardant additive and flame retardant synergist may be chosen so that it is retained during the diluent removal step. Flame retardant additives and synergists that have melting points above the processing temperatures may be used, and are incorporated into the microporous matrix as small particles that may not be removed during an oil removal step. Such additives may include high melting organic compounds such as decabromodiphenyl oxide. Alternatively, the additive and synergist may be chosen so that it is insoluble in a solvent used to remove the diluent. Yet alternatively, the flame retardant additive and synergists may be imbibed into an oil-out microporous film by conventional techniques.

When the flame retardant additive or synergist melts below the liquid-solid phase separation temperature, they frequently remain in the diluent phase upon cooling. Thus, porosity should generally be achieved through stretching since the flame retardant may be severely diminished if a substantial amount of the diluent is removed, even if the flame retardant is not miscible or soluble in the extraction solvent. Often, microporous films made with flame retardants that melt below the liquid-solid phase separation temperature can be thinner and appear more homogenous due to the lack of flame retardant particles in the polymer matrix. Conversely, when the flame retardant additive and/or synergist melt above the liquid-solid phase separation temperature, they frequently remain in the polymer matrix as discreet particles upon cooling and are generally not removed during an oil removal step.

If the diluent is removed, the resultant microporous article may be imbibed with various fillers to provide any of a variety of specific functions, thereby providing unique articles. For example, the imbibing material or filler may be a liquid, solvent solution, solvent dispersion or solid. Such filler may be imbibed by any of a number of known methods that results in the deposition of such fillers within the porous structure of the microporous sheet. Some imbibing materials are physically placed within the microporous sheet. In some instances, the use of two or more reactive components as the imbibing materials permits a reaction within the microporous sheet structure. Examples of imbibing materials include flame retardant additives, flame retardant synergists, antistatic agents, surfactants, odorants, antioxidants, UV stabilizers and solid particulate material such as activated carbon, polymeric coatings and pigments. Certain materials such as antistatic agents or surfactants, may be imbibed without removal of the compound or compatible liquid used as a carrier for the filler.

The flame retardant microporous article of the present invention may contain at least one layer of the above-described microporous material with at least one additional porous or non-porous layer. By way of example, in a three-layer system the above-described microporous layer is preferably the center layer sandwiched by, i.e., in between additional porous or non-porous layers. The additional layers of a multilayer article may include non-woven fabrics scrims or webs, woven fabrics or scrims, porous film, and non-porous film. Such materials may be bonded, laminated or otherwise affixed to the microporous film by, for example, pressing the microporous film and the web together in a nip between a smooth roll and a second roll (preferably having an embossing pattern on its surface) and heated sufficiently to soften the material facing the metal roll. Other bonding means such as are know in the art may also be used. Alternatively materials may be bonded by means of adhesives such as pressure-sensitive or hot-melt adhesives.

The microporous article may comprise a single microporous layer, or may comprise a multilayer article having at least one microporous layer as defined above. The article may include additional microporous layers, or additional nonporous layers, or one or more porous layers (such as a nonwoven layer) depending on the application and requirements.

The multilayer microporous films may include an (AB)ₙ construction, with either A and/or B layers as the outermost layers (e.g., (AB)ₙA, (BA)ₙB, or (AB)ₙ). In such constructions, each of the B layers has flame retardant properties as a result of the incorporation of a flame retardant additive and synergist, which may be the same or different in each layer, and each of the A layers does not have flame retardant and synergist, which may be the same or different in each layer and “n” is an integer from 0 to 1000, preferably 5 to 200, most preferably 5 to 50. In a particularly preferred embodiment, microporous layers are arranged in a A(BA)nBA multilayer construction.

In a particularly preferred embodiment, microporous layers are arranged in a A(BA)ₙBA multilayer construction where A represents microporous layers containing no flame retardant additive or synergist and B represents microporous layers that contain a flame retardant additive and synergist. Alternatively, A may represent microporous layers containing a flame retardant synergist and B represents microporous layers that contain a flame retardant additive.

Multilayer microporous films of the present invention can be prepared directly by coextrusion, for example, with the outermost layers being preferably non flame retardant. Frequently, incorporation of a flame retardant into one or both of the outermost layers can degrade the surface and/or mechanical properties of the outermost layer. Halogenated organic flame retardants, for example, may tend to migrate to the surface of the microporous film and render the surface non-amenable to further coating, by a pressure sensitive adhesive for example. Alternatively, the films can be made with one or both of the outermost layers being flame retardant layer(s) depending on the application.

The microporous film may be formed by extrusion (or coextrusion for a multilayer article) followed by cooling to cause phase transition and then orientation to form a porous film structure. The temperatures and other process conditions depend on the type of materials used and the properties desired from each layer, and are known or readily determined by those in the art. The coextrusion may employ a feedblock or a multi-manifold die at the extruder discharge. Cooling preferably is done by casting the multi-layer film onto a casting wheel or drum. In addition, the multi-layer film can be made by lamination means. Multilayer films comprising at least one flame retardant microporous layer may be prepared using a variety of equipment and a number of melt-processing techniques (typically, extrusion techniques) well known in the art. Such equipment and techniques are disclosed, for example, in U.S. Pat. No. 3,565,985 (Schrenk et al.), U.S. Pat. No. 5,427,842 (Bland et al.), U.S. Pat. No. 5,589,122 (Leonard et al.), U.S. Pat. No. 5,599,602(Leonard et al.), and U.S. Pat. No. 5,660,922-(Herridge et al.). For example, single- or multi-manifold dies, full moon feedblocks (such as those described in U.S. Pat. No. 5,389,324 to Lewis et al.), or other types of melt processing equipment can be used, depending on the number of layers desired and the types of materials extruded.

For example, one technique for manufacturing multilayer films of the present invention can use a coextrusion technique, such as that described in U.S. Pat. No. 5,660,922 (Herridge et al.). In a coextrusion technique, various molten streams are transported to an extrusion die outlet and joined together in proximity of the outlet. Extruders are in effect the “pumps” for delivery of the molten streams to the extrusion die. The particular extruder is generally not critical to the process. A number of useful extruders are known and include single and twin screw extruders, batch-off extruders, and the like. Conventional extruders are commercially available from a variety of vendors such as Davis-Standard Extruders, Inc. (Pawcatuck, Conn.), Black Clawson Co. (Fulton, N.Y.), Berstorff Corp. (KY); Farrel Corp. (CT), and Moriyama Mfr. Works, Ltd. (Osaka, Japan).

Flame retardant additives and synergists are added in sufficient amounts to render the multilayer film flame retardant. Generally the additives are added in amounts of 10 parts by weight or less in each flame retardant layer and synergists in amounts of 0.1 to 2 parts by weight. Preferably the additives are added in amounts of at least 1 to 10 parts by weight in each flame retardant layer, or in the amounts of 1 to 10 parts by weight of the unified multilayer article. The flame retardant synergists are generally added on amounts of 0.1 to 2 parts by weight of the unified multilayer article. Advantageously, such multilayer constructions improve flame retardant efficiency; the same flame retardant properties may be obtained using an lesser amount of flame retardant additive relative to a single layer construction.

The microporous articles of the present invention may be employed in any of a wide variety of situations wherein microporous structures may be utilized. The articles are especially useful in applications where there is a possibility of exposure to heat or an ignition source. By incorporating flame retardant additives into a microporous article, porous films are provided which are difficult to ignite, which propagate flame much more slowly and which may be self-extinguishing. Such applications include clothing, wall or roofing barriers (such as moisture vapor transmission barriers), optical films in electronic devices (such as light reflective and dispersive films), printing substrates and electrical insulation.

The flame retardant microporous films of the invention are particularly useful as barrier films (e.g. moisture-vapor barrier films) in construction, such as on roofs or exterior walls. These films can render a building (or portion thereof) moisture-resistant by allowing water vapor to pass through the film, but not liquid water. In many places building materials are subject to increasingly severe restrictions regarding flammability; building codes may require that barrier films be non-flammable or fire-resistant. The films are attached to the building exterior to the sheathing and beneath the roofing tiles, shingles, etc. of a roof or beneath the exterior siding, shingles or panels of an exterior wall. The microporous film may be single or multilayer, and may preferably include a scrim or web for added strength or tear resistance. The film may be attached to an exterior surface by any conventional means such as nails, tacks, staples or adhesives.

The microporous articles of the present invention are also useful in a variety of light management applications such as diffuse reflectors. For example, they may be used as a back reflector in liquid crystal display (LCD) and light emitting diode (LED) backlight constructions. The diffuse reflective materials of the present invention may also be used to increase the brightness of sign cabinets, light fibers, and light conduits. The light diffusing article may be used to partially line an optical cavity to increase the efficient use of light to illuminate such things as, for example, a partially transparent image that may be either static (such as a graphics film or a transparency) or switchable (such as a liquid crystal display). Thus, optical cavities that are partially lined with diffuse reflector films of the invention may be used in such devices as backlight units such as liquid crystal display constructions (LCDs), lights, copying machines, projection system displays, facsimile apparatus, electronic blackboards, diffuse light standards, and photographic lights. They may also be part of a sign cabinet system, a light conduit or units containing light emitting diodes (LEDs).

Thus, for example, the diffuse reflective article of the present invention has been found to be especially beneficial as a back reflector in commercial back lights used for liquid crystal displays. In this type of application, the film is placed directly behind the light source which is illuminating a display. The porous film simply acts to reflect back all the light that is not directed toward the display and ultimately a viewer. The scattering or diffuse reflection characteristics of the porous film back reflector also helps provide a more overall diffuse light source and more evenly lit display, and are suitable as diffuse reflector and polarization randomizers as described in Patent Application Publication No. WO 95/17699 and U.S. Pat. No. 6,111,696. Such articles containing the flame retardant diffuse reflective material of the present invention are further aspects of the present invention.

The unique morphology resulting from diffuse reflectors made via the solid/liquid process is particularly useful in making a practical reflector having high diffuse reflection and flame retardancy. The morphology of the solid medium has small dimensions because it is formed by phase separating a polymer and a diluent from a solution. The articles have solid and air regions (or void spaces) of a particular size and comprise materials that do not absorb radiation in the wavelength desired to be diffusely reflected. Thus, for the diffuse reflection of visible light, 380-730 nanometers, the polymer materials preferred are, for example, polyolefins such as polypropylene, polyethylene; copolymers of ethylene and vinyl acetate, or compatible mixtures thereof. Also, because diluent and flame retardant may be present in varying amounts, they should also be non-absorbing.

The present invention also provides a flame retardant, breathable moisture barrier suitable for use in enclosing flexible electrodes, foam substrate and other electrical components within a substantially liquid impervious environment without significantly impairing the ability of electrical sensors to accurately measure temperature and humidity variations within the surrounding environment such as the seating compartment of an automobile. The invention comprises the instant flame retardant microporous film or article having a sufficiently high moisture vapor transmission rate (MVTR) to permit water vapor to be transported across the barrier and quickly reach equilibrium within the enclosed seat sensor mat assembly and to allow the temperature and humidity compensation of the occupant sensing system to function correctly. The breathable moisture barrier of the present invention provides a sufficiently high MVTR to allow rapid temperature and humidity equilibration within the sensor mat so as to better track rapid changes in the passenger compartment environmental conditions upon starting the car and applying either air conditioning or heating.

In one example of a seat sensor mat assembly for use in automotive applications, the assembly will consist of a number of electrically conductive sensor strips adhesively attached to the top and bottom surfaces of an open celled, flexible polyurethane foam core. Each sensor strip is connected to an electronic control unit that operates the occupant sensing system by measuring impedance changes in an electric field around each of the sensor strips based on an occupant's size and presence. The seat sensor mat assembly may be designed to be incorporated into a hollowed out portion of the bottom cushion of an automobile seat.

Since the occupant sensing system uses electric field sensing technology, water or other liquids spilled on the seat could impair the ability of the sensing system to function properly. Water and other conductive liquids prevent the system from sensing occupant changes accurately because the conductive liquid creates coupling and shorts between adjacent conductive strips on the seat sensor mat assembly.

One solution to this problem would be to enclose the seat sensor mat assembly entirely within a liquid impervious polymeric film. This is much like wrapping or coating the seat sensor mat assembly with a non-porous, non-breathable polymer film to keep water out. However, this solution presents additional problems by creating very different environmental conditions, namely temperature and humidity, inside the seat sensor mat assembly and in the surrounding passenger compartment of the automobile. The dielectric properties of the materials and gases of the environment surrounding the conductive strips are temperature and humidity dependent. Sealing the entire assembly in a manner that is impervious to both liquids and gases make temperature and humidity compensation of the electric field data significantly more difficult. This solution may ultimately require a temperature and humidity sensor both inside the seat sensor mat assembly and externally within the passenger compartment. Comfortability issues may also arise as air that is trapped inside the sealing material will be unable to escape and will be compressed as the seat is compressed. It is also notable that should any moisture become trapped inside the seat sensor mat assembly, it is quite possible that it will create mildew and other nondesirable conditions inside the assembly. An additional comfort problem may arise from perspiration trapped in the seat trim that is in contact with the occupant.

Accordingly, a breathable moisture barrier (comprising the flame retardant microporous film or article of the invention) would provide a number of advantages in an occupant sensing system. A breathable moisture resistant fabric can be used to create a positive seal of the open celled foam preventing water uptake. Additionally, breathability permits a uniform temperature and humidity environment between the seat sensor mat assembly and the passenger compartment. This uniform environmental condition allows a single temperature/humidity sensor to be incorporated into the seat sensor mat assembly to characterize the environment of both the assembly itself and the passenger compartment. Moreover, temperature and humidity compensation of the electric field data is made easier due to the consistent dielectric properties of the materials and gases within the seat sensor mat assembly, seat trim materials and the passenger compartment. A breathable moisture barrier may advantageously prevent any moisture from collecting or mildewing in the seat sensor mat assembly, seat trim materials or seat bun. Although a breathable membrane will usually not allow a sufficient amount of air to escape from the seat sensor mat assembly as a passenger sits down, ventilation holes may be easily incorporated on the bottom surface of the assembly and a transfer adhesive, used to adhere the sensor mat to the seat bun may be further utilized at the edges of the ventilation holes to prevent moisture from entering the assembly. Further details regarding moisture barrier may be found in Assignee's copending application U.S. Ser. No. 10/196,997, incorporated herein by reference.

### EXAMPLES

This invention is further illustrated by the following examples that are not intended to limit the scope of the invention. In the examples, all parts, ratios and percentages are by weight unless otherwise indicated. The following test methods were used to characterize the flame retardant films in the examples:

Test Methods

Horizontal Burn

Burning characteristics of the films were evaluated; according to the horizontal burn test Federal Motor Vehicle Safety Standard 571.302, Flammability of Interior Materials. Film samples were cut into strips having a width of 102 mm and a length of 356 mm. Two strips were cut in the machine direction of the film and tested. Each strip was mounted in a U-shaped support fixture (51 mm wide by 330 mm long, interior dimensions) and held in a horizontal position so that the bottom edge of the open end of the specimen was located 19 mm above the center of a Bunsen burner tip. The burner flame was set to 38 mm with the air inlet to the burner closed. The flame was slid into the open edge of the sample and applied for 15 seconds. If the flame front reached a point 38 mm from the open end of the specimen, a timer was started. The time for the flame to reach a point 38 mm from the clamped end of the specimen was recorded. If the flame did not reach the specified end point, the time was recorded at the point when flaming stopped. The burn rate was calculated from the average of the two test strips. The material was considered to have passed the 571.302 standard if (a) the burn rate did not exceed 102 mm per minute or (2) the material stopped burning before it has burned for 60 seconds from the start of timing and had not burned more than 51 mm from the point where the timing was started.

Gurley Air Flow

This test is a measurement of time in seconds required to pass 50 cm³ of air through a film according to ASTM D-726 Method B. A value of greater than 10,000 sec/50 cm³ is assigned if the Gurley timer does not start after 100 seconds from the start of the test.

Materials Used

DS 5D45: Polypropylene homopolymer, 0.7 g/min MFI (ASTM D 123 8, Condition 1), (Dow Chemical Co., Midland, Mich.).

51S07A: Polypropylene homopolymer, 0.8 g/min MFI (ASTM D 123 8, Condition 1), (Equistar Chemical Co., Houston, Tex.).

MILLAD 3988: Nucleating agent, 3,4-dimethylbenzyl idine sorbitol, (Milliken Chemical Co., Inman S.C.).

Mineral oil: Superla White No. 31, viscosity of 100 centistokes (ASTM D445 at 40° C.), 0.867 specific gravity, (Amoco Chemical Co.,)

DE 83R: Decabromodiphenyloxide, average particle size of 4 microns, (Great Lakes Chemical, West Lafayette, Ind.).

DE 79: Octabromodiphenyl oxide, (Great Lakes Chemical, West Lafayette, Ind.).,

NOR-116: monomeric n-alkoxy hindered amine, 110-125° C. melting point, 260° C. boiling point, 1.10 density, (Ciba Specialty Chemicals, Tarrytown, N.Y.)

FR-370: tris(tribromoneopentyl) phosphate, aliphatic brominated flame retardant, 79% bromine content, 181° C. melting point, 2.30 density, (Dead Sea Bromine Group, Beer Shiva, Israel)

FYREBLOC 203: masterbatch concentrate consisting of 80.75% DE-79, 15% paraffin wax and 4.25% Anox 20, (Great Lakes Chemical, West Lafayette, Ind.).

FIREMASTER 2100; decabromodiphenyl ethane, (Great Lakes Chemical, West Lafayette, Ind.).

IRGANOX 1010: pentaerythritol tetrakis (3-(3,5-di-tert-butyl-4-hydroxyphenyl)propionate), (Ciba Specialty Chemicals, Tarrytown, N.Y.)

ANOX 20: steric hindered phenolic antioxidant, (Great Lakes Chemical, West Lafayette, Ind.).

### Comparative Example C1

DS 5D45 polypropylene was mixed with a polypropylene/nucleating agent concentrate (97.5% PP, 2.5% MILLAD 3988), and fed into the hopper of a 40 mm twin-screw extruder. A mineral oil diluent was introduced into the extruder through an injection port at a rate to provide a composition of 62.5% by weight of the polypropylene, 37.5% by weight mineral oil and 800 parts per million of nucleating agent. No flame retardant was used. The composition w as rapidly heated to 271° C. in the extruder to melt the components after which the temperature was cooled down to and maintained at 204° C. through the remainder of the barrel. The molten composition was pumped from the extruder using a melt pump via a necktube through a 100-micron filter and then into a coat hanger slit die. The melt curtain was then cast onto a chrome roll (65° C.) and then wound-into a roll of film. In a subsequent step the cast film was stretched 1.7 to 1 in both the machine and cross directions sequentially using a Killion length orienter (52° C.) and a Cellier tenter (115° C.-130° C.) to form an opaque microporous film having a thickness of about 44 microns.

### Examples 1-12

Microporous films were prepared as in Comparative Example C1 above except flame retardant and other additives were added at various percentages. The additives were dispersed into the mineral oil to provide appropriate weight percentages. The thicknesses of the films ranked from 40 microns to 48 microns. The compositions of the films are shown in Table 1 below. The physical properties and burn test data are shown in Table 2.

TABLE 1

| | % DE-79 flame | % NOR-116 | % IRGANOX | % mineral oil |
|---|---|---|---|---|
| Film | retardant | synergist | antioxidant | diluent |
| C1 | 0 | 0 | 0 | 37.5 |
| C2 | 2.5 | 0 | 0 | 39 |
| C3 | 5.5 | 0 | 0 | 36 |
| C4 | 8.5 | 0 | 0 | 33 |
| 1 | 2.5 | 0.25 | 0 | 38.75 |
| 2 | 5.5 | 0.25 | 0 | 35.75 |
| 3 | 8.5 | 0.25 | 0 | 32.75 |
| 4 | 2.5 | 0.5 | 0 | 38.5 |
| 5 | 5.5 | 0.5 | 0 | 35.5 |
| 6 | 8.5 | 0.5 | 0 | 32.5 |
| 7 | 2.5 | 2.0 | 0 | 37 |
| 8 | 5.5 | 2.0 | 0 | 34 |
| 9 | 8.5 | 2.0 | 0 | 31 |
| 10 | 2.5 | 2.0 | 0.65 | 37 |
| C5 | 2.5 | 0.0 | 0.65 | 39 |
| 11 | 2.5 | 0.25 | 0.65 | 38.75 |
| 12 | 2.5 | 0.5 | 0.65 | 38.5 |

TABLE 2

| | Gurley Time | Porosity | Burn Rate MD | Burn Test |
|---|---|---|---|---|
| Film | (sec/50 cm³) | (%) | (mm/min) | (Pass/Fail) |
| C1 | — | — | 1338 | Fail |
| C2 | 117 | 44.5 | 0 | Pass |
| C3 | 127 | 43.3 | 0 | Pass |
| C4 | 102 | 40.5 | 0 | Pass |
| 1 | 16 | 47.8 | 0 | Pass |
| 2 | 20 | 45.0 | 0 | Pass |
| 3 | 22 | 44.0 | 0 | Pass |
| 4 | 16 | 46.8 | 0 | Pass |
| 5 | 17 | 45.6 | 0 | Pass |
| 6 | 24 | 43.3 | 0 | Pass |
| 7 | 17 | 46.3 | 0 | Pass |
| 8 | 17 | 45.0 | 0 | Pass |
| 9 | 15 | 45.1 | 0 | Pass |
| 10 | 9 | 49.2 | 0 | Pass |
| C5 | 17 | 46.7 | 1255 | Fail |
| 11 | 17 | 47.3 | 625 | Fail |
| 12 | 16 | 47.2 | 0 | Pass |

### Examples 13-20

Microporous films were prepared as in Examples 1-12 above except a 25 mm twin screw extruder was used to melt mix the components using similar process conditions. Solid non-melting flame retardants were used at various percentages with the NOR-116 synergist. The additives were dispersed into the mineral oil to provide appropriate weight percentages. No antioxidant was added to the composition. The thicknesses of the films ranged from 40 microns to 48 microns. The compositions of the films are shown in Table 3 below. The burn test data are shown in Table 4.

### Comparative Examples C6-C9

Microporous films were prepared as in Examples 13-20 except no synergist was used.

TABLE 3

| | % DE-83R | % Firemaster | | |
|---|---|---|---|---|
| | flame | 2100 flame | % NOR-116 | % mineral |
| Film | retardant | retardant | synergist | oil diluent |
| C6 | 10 | | 0 | 36.5 |
| C7 | 15 | | 0 | 36.5 |
| 13 | 10 | | 1.0 | 35.5 |
| 14 | 8.5 | | 1.0 | 35.5 |
| 15 | 5.5 | | 1.0 | 35.5 |
| 16 | 2.5 | | 1.0 | 35.5 |
| C8 | | 10 | 0 | 36.5 |
| C9 | | 15 | 0 | 36.5 |
| 17 | | 10 | 1.0 | 35.5 |
| 18 | | 8.5 | 1.0 | 35.5 |
| 19 | | 5.5 | 1.0 | 35.5 |
| 20 | | 2.5 | 1.0 | 35.5 |

TABLE 4

| | Burn Rate MD | Burn Test |
|---|---|---|
| Film | (mm/min) | (Pass/Fail) |
| C6 | 348 | Fail |
| C7 | 214 | Fail |
| 13 | 0 | Pass |
| 14 | 0 | Pass |
| 15 | 0 | Pass |
| 16 | 383 | Pass |
| C8 | 0 | Pass |
| C9 | 461 | Pass |
| 17 | 540 | Pass |
| 18 | 1003 | Pass |
| 19 | 1467 | Pass |
| 20 | 772 | Fail |

### Example 21, Comparative Example C10

Microporous films were prepared as in Examples 13-20 above except FR-370 flame retardant was used with and without the NOR-116 synergist. No antioxidant was added to the composition. The compositions of the films are shown in Table 5 below. The burn test data are shown Table 6.

TABLE 5

| | % FR-370 | | |
|---|---|---|---|
| | flame | % NOR-116 | % mineral |
| Film | retardant | synergist | oil diluent |
| C10 | 2.0 | 0 | 35 |
| 21 | 2.0 | 1.0 | 35 |

TABLE 6

| | Burn Rate MD | Burn Test |
|---|---|---|
| Film | (mm/min) | (Pass/Fail) |
| C10 | 0 | Pass |
| 21 | 0 | Pass |

### Examples 22-23, Comparative Examples C 11-C 15

Microporous films were prepared as in Examples 13-20 above with various combinations of DE-79 flame retardant with and without the NOR-116 synergist. No. antioxidant was added to the composition. The compositions of the films are shown in Table 7 below: The physical properties and burn test data are shown in Table 8.

TABLE 7

| | % DE-79 | | |
|---|---|---|---|
| | flame | % NOR-116 | % mineral |
| Film | retardant | synergist | oil diluent |
| C11 | 0 | 0 | 35 |
| C12 | 0 | 0.5 | 35 |
| C13 | 0 | 1.0 | 35 |
| C14 | 0 | 2.0 | 35 |
| C15 | 0 | 4.0 | 35 |
| 22 | 4.2 | 1.0 | 35 |
| 23 | 6.3 | 1.0 | 35 |

TABLE 8

| | Gurley Time | Burn Rate MD | Burn Test |
|---|---|---|---|
| Film | (sec/50 cm³) | (mm/min) | (Pass/Fail) |
| C11 | 93 | 1240 | Fail |
| C12 | 79 | 821 | Fail |
| C13 | 112 | 0 | Pass |
| C14 | 55 | 412 | Fail |
| C15 | 22 | 963 | Fail |
| 22 | 53 | 0 | Pass |
| 23 | 52 | 0 | Pass |

### Examples 24-29. Comparative Examples C16-C19

Microporous films were prepared as in Examples 1-12 above except FYREBLOC 203 concentrate and synergist were added at various percentages. The concentration of the MILLAD 3988 nucleating agent was 0.08%. The thicknesses of the films ranged from 40 microns to 48 microns. The compositions of the films are shown in Table 9 below. The burn test data are shown in Table 10.

TABLE 9

| | % DE-79 | | | | |
|---|---|---|---|---|---|
| | flame | % NOR-116 | % ANOX | % Paraffin | % mineral |
| Film | retardant | synergist | antioxidant | wax | oil diluent |
| C16 | 0 | 0 | 0 | 0 | 37.5 |
| 24 | 2.0 | 0.5 | 0.11 | 0.37 | 34.3 |
| 25 | 3.1 | 0.5 | 0.16 | 0.58 | 33.3 |
| 26 | 4.2 | 0.5 | 0.22 | 0.78 | 32.0 |
| 27 | 4.2 | 1.0 | 0.22 | 0.78 | 31.5 |
| 28 | 3.1 | 1.0 | 0.16 | 0.58 | 32.8 |
| 29 | 2.0 | 1.0 | 0.11 | 0.37 | 34.1 |
| C17 | 2.0 | 0 | 0.11 | 0.37 | 35.1 |
| C18 | 3.1 | 0 | 0.16 | 0.58 | 33.8 |
| C19 | 4.2 | 0 | 0.22 | 0.78 | 32.5 |

TABLE 10

| | Burn Rate MD | Burn Test |
|---|---|---|
| Film | (mm/min) | (Pass/Fail) |
| C16 | 1320 | Fail |
| 24 | 0 | Pass |
| 25 | 0 | Pass |
| 26 | 0 | Pass |
| 27 | 0 | Pass |
| 28 | 150 | Pass |
| 29 | 193 | Pass |
| C17 | 992 | Fail |
| C18 | 1600 | Fail |
| C19 | 906 | Fail |

### Example 30

To demonstrate that the flame retardant films of the invention can be used in laminate constructions, the film of Example 5 was adhesively laminated to a 20 gram/square meter polypropylene spunbond nonwoven (First Quality Nonwovens, Great Neck, N.Y. 11020) using general purpose 3M 6111 Hot Melt Adhesive (3M Company, St. Paul, Minn.) applied with a PAM. 600 Spray Melt Gun (Fastening Tech Inc., Charlotte, N.C.). The adhesive was first heated to 176° C. and then sprayed in a circular pattern onto the nonwoven. The flame retardant microporous film was then immediately placed onto the nonwoven and rolled with a hand held roller. The laminate was tested for Burn Rate using 6 samples. Five of the, samples did not ignite and the sixth self-extinguished.

We claim:

1. A microporous article comprising:
(a) 20 to 90 parts by weight of a crystallizable thermoplastic polymer component;
(b) 0.1 to 70 parts by weight of an diluent component, said diluent component being miscible with the polymer component at a temperature above the liquid-solid phase separation temperature and able to phase separate from the polymer component through crystallization separation upon cooling below the liquid-solid phase separation temperature; and
(c) 1 to 10 parts by weight of a flame retardant additive; and
(d) 0.1 to 2 parts by weight of a hindered (cyclo)alkoxyamine synergist.

2. The microporous article of claim 1 wherein said hindered amine synergist comprises a moiety of the formula R¹O—NR²R³, wherein
R¹ is an alkyl group, a cycloalkyl group, an aryl group, or combinations thereof, optionally substituted with one or more hydroxy groups;
R² and R³ are independently an alkyl group, a cycloalkyl group, an aromatic group and may be substituted by one or more hydroxy groups, wherein R² and R³ may be taken together to form a heterocyclic ring and at least one of R² and R³ have a secondary or tertiary carbon atom alpha to the nitrogen atom.

3. The microporous article of claim 1 wherein said hindered amine synergist is a secondary or tertiary amine having 2 secondary or tertiary carbon atoms alpha to the nitrogen atom.

4. The micropororous article of claim 3, wherein said hindered amine comprises a tetralkyl piperidinyl moiety.

5. The micropororous article of claim 3, wherein said hindered amine is a polymer having pendent tetralkyl piperidinyl groups.

6. The microporous article of claim 1 comprising greater than 10 parts by weight diluent.

7. The microporous article of claim 1 comprising 15 to 70 parts by weight diluent.

8. The article of claim 1, wherein the polymer component is a polyolefin, a polyolefin copolymer, a polyolefin blend or a mixture thereof.

9. The article of claim 8, wherein the polyolefin is polypropylene or high density., polyethylene.

10. The article of claim 1, wherein the diluent is selected from the group of dioctyl phthalates, diethyl phthalates, dibutyl phthalate, mineral oil, mineral spirits, triethyleneglycol, methylnonylketone, decanoic acid, oleic acid, decyl alcohol, and a, mixture thereof.

11. The article of claim 1 wherein the flame retardant additive is selected from the group of halogenated organic flame retardants, and organic phosphorus-containing flame retardants.

12. A multilayer microporous film comprising at least one layer of a microporous material according to claim 1.

13. The multilayer film of claim 12 further comprising at least one additional layer selected from the group consisting of non-woven fabric, woven fabric, porous film, and non-porous film.

14. The multilayer film of claim 12 having an (AB)ₙA construction wherein each A layer is a non-flame retardant layer, each B layer is a flame retardant layer and n is an integer from 2 to 50.

15. A moisture barrier film comprising the microporous film of claim 12.

16. A method of making a microporous article, comprising:
(a) melt blending to form a solution comprising 20 to 90 parts by weight of a polymer component, 15 to 70 parts by weight of an diluent component, said diluent component being miscible with the polymer component at a temperature above the liquid-solid phase separation temperature; 1 to 10 parts by weight of a flame retardant additive, and 0.1 to 2 parts by weight of a hindered amine synergist;
(b) forming a shaped article of the melt blended solution;
(c) cooling said shaped article to a temperature below the liquid-solid phase separation temperature at which phase transition occurs between the diluent component and the polymer component through crystallization precipitation of the polymer component to form a network of polymer domains;
(d) creating porosity by means of a process selected from removing at least a portion of said diluent and
orienting said article at least in one direction to separate adjacent crystallized polymer domains from one another to provide a network of interconnected micropores therebetween.

17. The method of claim 16 wherein the flame retardant additive is selected from the group of halogenated organic flame retardants, organic phosphorus-containing flame retardants, and inorganic flame retardants.

18. The method of claim 16, wherein the polymer component is polypropylene or high density polyethylene.

19. The method of claim 16, wherein said diluent is selected from dioctyl phthalates; diethyl phthalates, dibutyl phthalate, mineral oil, mineral spirits, triethyleneglycol, methylnonylketone, decanoic acid, oleic acid, decyl alcohol, and a mixture thereof.

20. The method of claim 16 further comprising the step of bonding a microporous polymer film to a web selected from the group consisting of non-woven fabric, woven fabric, porous film, and non-porous film.

21. The method of claim 20 further comprising the step of bonding a microporous polymer film to a web selected from the group consisting of non-woven fabric, woven fabric, porous film, and non-porous film; said method comprising pressing the microporous film and the web together in a nip between a smooth roll and a roll having an embossing pattern on its surface and heated sufficiently to soften the material facing the embossed roll.

22. A method for preparing a multilayer microporous film according to claim 16 wherein said forming step further comprises simultaneously coextruding a melt-processible organic polymeric material to form a unified construction of at least 2 substantially contiguous layers of organic polymeric material, wherein at least one layer comprises a microporous flame retardant film layer.
